(19) United States
(12) Patent Application Publication
(10) Pub. No.: US 2008/0172460 A1
(43) Pub. Date: Jul. 17, 2008

(54) INVITATION ORDER SYSTEM, METHOD AND MEDIUM

(76) Inventor: Bryan Douglas Anderson, Carmel, IN (US)

Correspondence Address: BARNES & THORNBURG LLP, 11 SOUTH MERIDIAN, INDIANAPOLIS, IN, 46204, US

(21) Appl. No.: 11/622,266

(22) Filed: Jan. 11, 2007

(51) Int. Cl. G06F 15/16

(52) U.S. Cl. 709/204

(57) ABSTRACT

A networked invitation order environment is disclosed which includes an invitation order system, an invitee computing device, and inviter computing device. The invitation order system provides invitation order services for a restaurant. An inviter uses the inviter computing device to define an invitation order for the restaurant. The invitation order system sends an invitation to each invitee associated with the invitation order. Each invitee receives their invitation via an invitee computing device. Each invitee via an invitee computing device communicates with the invitation order system to obtain a menu for the restaurant and to update the invitation order with their selected items from the restaurant menu. The invitation order system provides a communication device of the restaurant with details of the invitation order including the menu items selected by each invitee. The restaurant prepares the selected menu items and fulfills the invitation order.

### BACKGROUND

Restaurants over the years have adjusted with the times to provide their patrons with innovative and unique services. For example, over the past few decades fast food restaurants were developed to address a need for quick and low cost meals on demand. Many restaurants over the years have added drive thru or pick-up windows, call ahead take-out or pick-up services, as well as delivery services to homes and/or businesses. For many years, restaurants have used plain old telephone services to support their pick-up and delivery business. Under such services, a patron called the restaurant and placed an order via a telephone for delivery or pick-up. Pizzerias have had success with their call for delivery and/or call for pick-up over the years. Other restaurants, such as American Chinese food restaurants, have also had success with their call for delivery and/or call for pick-up services.

More recently, restaurants have expanded their delivery and/or pick-up services by adding support for orders that are placed via the Internet. In particular, the restaurants have established an Internet presence via a web server that patrons may connect to using a standard web client or browser. Via the web client, the patron may place an order with the restaurant which the patron may later pick-up from the restaurant or have delivered to a specified location.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 depicts an invitation order environment for a restaurant.

FIG. 2 depicts a computing device of the invitation order environment.

FIG. 3 depicts a method of initiating a invitation order for a restaurant.

FIG. 4 depicts a method of handling invitee orders of an invitation order.

FIG. 5 depicts a pending invitation order page provided by an invitation order system.

FIG. 6 depicts a invitation order summary page provided by an invitation order system.

### DETAILED DESCRIPTION

The following description describes techniques of generating an invitation order for a restaurant that enables invitees to select and add menu items such as entrees, sides, beverages, and desserts to the invitation order. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; and others.

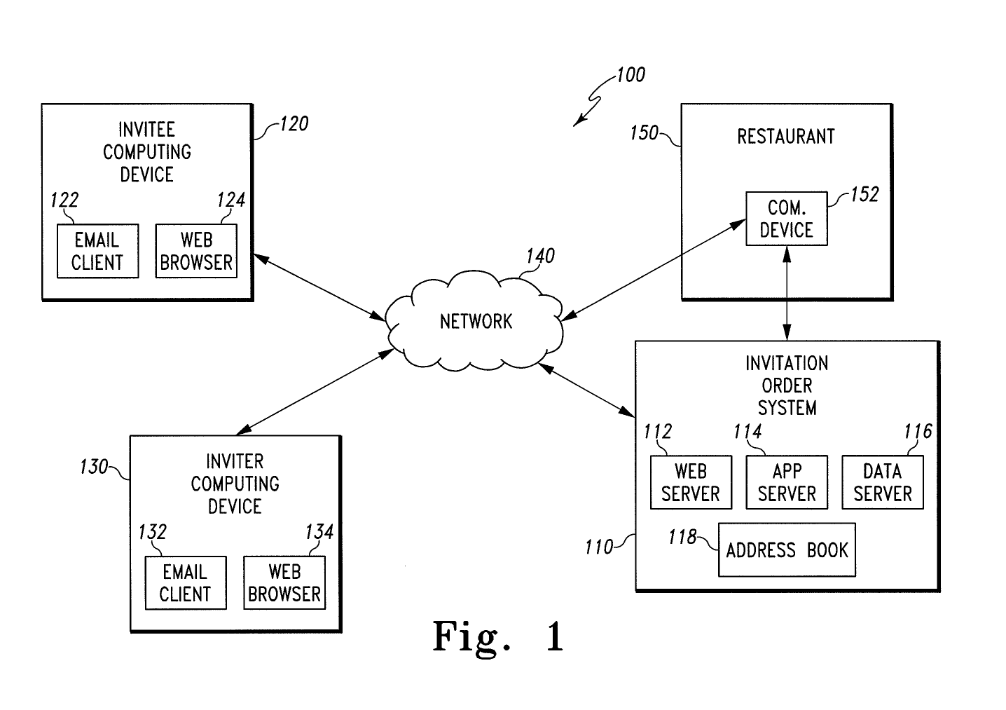

Referring now to FIG. 1, a networked invitation order environment 100 comprising an invitation order system 110, an invitee computing device 120, and inviter computing device 130 is depicted. The invitation order system 110 may provide invitation order services for a restaurant 150 via a network 140. In particular, an inviter or host may use the inviter computing device 130 to define or otherwise initiate an invitation order for a restaurant 150. In response to defining the invitation order, the invitation order system 110 may send an invitation to each invitee associated with the invitation order. Each invitee may receive their invitation via an invitee computing device 120. In response to the invitation, each invitee via an invitee computing device 120 may communicate with the invitation order system 110 to obtain a menu for the restaurant 150 and to update the invitation order with their selected items from the restaurant menu. The invitation order system 110 may provide a communication device 152 of the restaurant 150 with details of the invitation order including the menu items selected by each invitee, the time and day the invitation order is to be fulfilled, and the manner in which the restaurant 150 is to fulfill the order (e.g. dine-in, carry-out, or delivery). The restaurant 150 may then prepare the selected menu items and fulfill the invitation order in the manner and at the time defined for the invitation order.

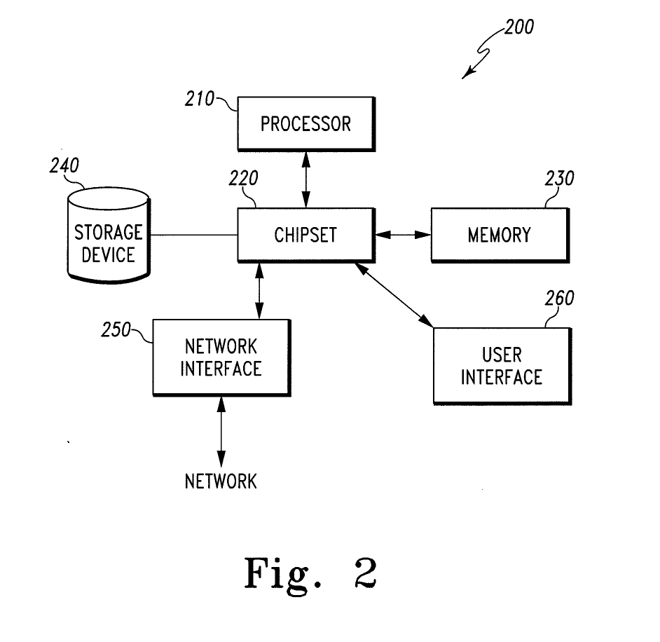

Referring now to FIG. 2, a computing device 200 is depicted which comprises a processor 210, a chipset 220, memory 230, a storage device 240, a network interface 250, and a user interface 260. The computing device 200 may be suitable for the computing devices of the invitation order environment 100 such as computing devices used to implement the invitation order system 110, the invitee computing device 120, the inviter computing device 130, and/or the restaurant communication device 152. However, computing devices of the invitation order environment 100 may utilize a different architecture than the architecture depicted in FIG. 2. For example, some of the computing devices of the invitation order environment 100 may be implemented as “headless” devices that comprise no user interface 260. Such headless devices may require no user configuration or may rely on user interfaces 260 of other computing devices to configure the headless device via the network 140.

The processor 210 may comprise one or more logic cores for executing instructions stored in memory 230. The processor 210 may further comprise various cache memories, firmware, microcode, interrupt controllers, memory controllers, timers, and/or other circuitry which aid or support the execution of instructions by the processor 210. The chipset 220 may comprises a memory controller, direct memory access controllers, audio controllers, network controllers, graphics controllers, disk controllers, interrupt controllers, real time clocks, and/or other support circuitry to control the flow of data between components (e.g. processor 210, memory 230, storage device 240, network interface 250, and user interface 260) of the computing device 200. To this end, the chipset 220 may further comprise interface controllers that are compliant with interconnect technologies such as, for example, Universal Serial Bus (USB) controllers, Peripheral Component Interconnect (PCI) Express controllers, IEEE 1394 (Firewire) controllers, Serial ATA controllers, and others.

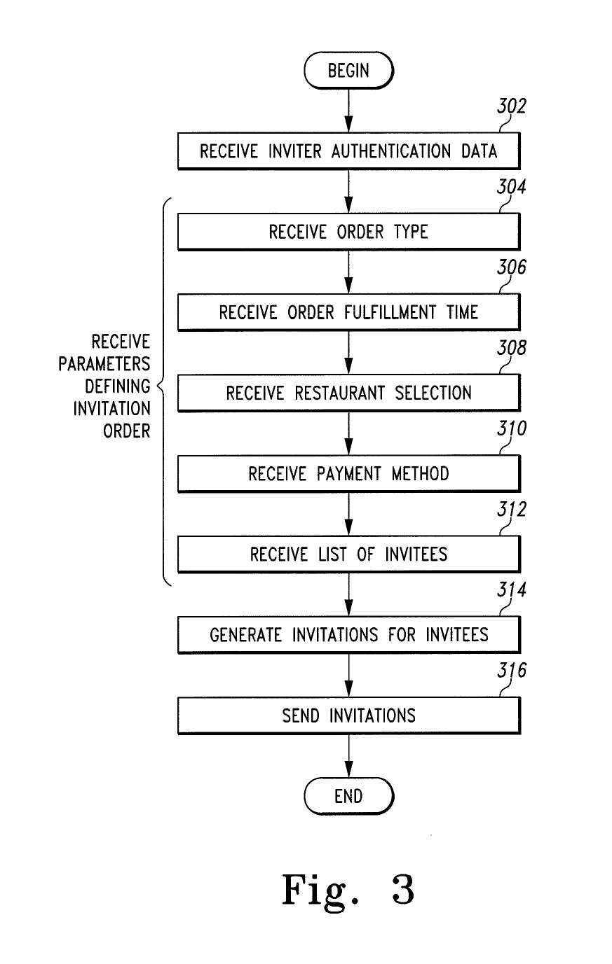

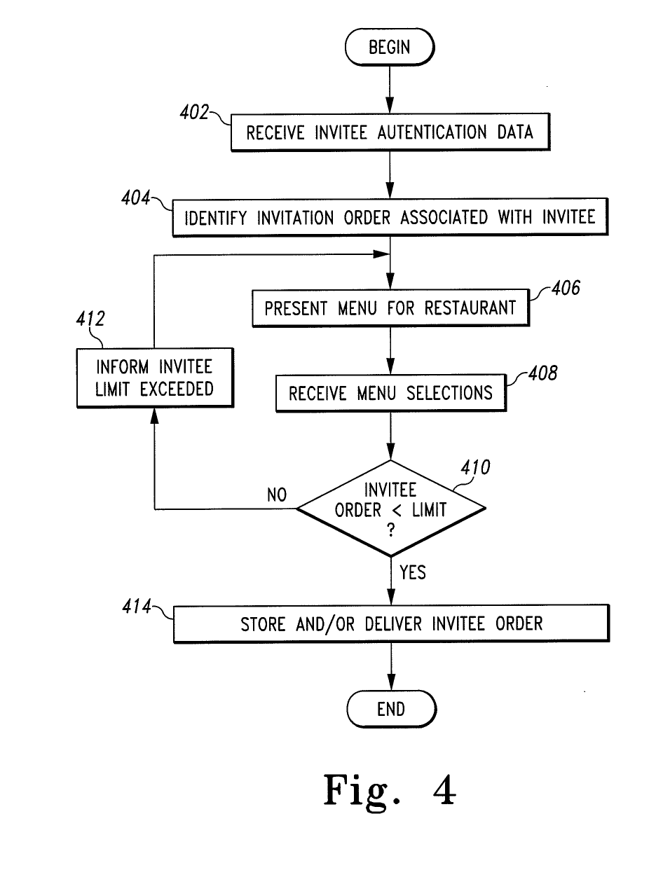

The memory 230 and/or storage device 240 may store firmware and/or software instructions which in response to being executed by the processor 210 results in the computing device 200 performing various operations of the invitation order process. Such operations are presented in further detail below in regard to the flowcharts of FIGS. 3 and 4. The memory 230 may comprise various volatile memory devices such as, for example, random access memory (RAM) devices, synchronous dynamic RAM (SDRAM) devices, double data rate (DDR) SDRAM devices, and static RAM (SRAM) devices. The memory 230 may also comprise various non-volatile memory devices such as, for example, read only memory (ROM) devices, programmable ROM (PROM) devices, electronically erasable PROM (EEPROM) devices, and flash memory devices.

The storage device 240 may comprise various electromagnetic, optical, and/or some other mass storage technology devices such as hard disk drives, tape drives, redundant array of independent devices (RAID) devices, compact disc drives, and DVD drives. As mentioned above, the storage device 240 may store software which the processor 210 may execute in order to perform various operations of the invitation order process. In particular, the storage device 240 in an embodiment may store such software in a non-volatile manner for later execution by the processor 210. Furthermore, the storage device 240 may store data such as files, documents, web pages, databases, and the like which the processor 210 may read, write, or/otherwise access in support of the invitation order process.

The network interface 250 may comprise wired and/or wireless interfaces for coupling the computing device with the network 140. For example, the network interface 250 may be compliant with IEEE 802.3 (Ethernet), IEEE 802.11 (WiFi), IEEE 802.16 (WiMAX), or some other networking technology. The user interface 260 may comprise various input and/or output devices which enable a user of the computing device 200 to input data into the computing device and receive data from the computing device 200. Example input devices include but are not limited to mice, keyboards, touch screens, buttons, and microphones. Similarly, example output devices include but are not limited to printers, CRT displays, digital flat panel displaces, light emitting diodes, and audio speakers.

In one embodiment, the communication device 152 of the restaurant 150 may comprises a computing device such as computing device 200. The communication device 152 may be coupled to the invitation order system 110 via the network 140 via a digital subscriber line modem, cable modem, a wireless interface such as a WiMAX, or a POTS (plain old telephone service) modem. In such an embodiment, a public network such as the Internet may be used to couple the communication device 152 with the invitation order system 110; however, a private network or a virtual private network may also be established between the communication device 152 and the invitation order system 110. In other embodiments, the communication device 152 may comprise a telephone or a fax machine which may receive invitation order details from the invitation order system 110 via plain old telephone networks or other telephone networks.

The invitee computing devices 120 and the inviter computing devices 130 may be implemented in a manner similar to depicted computing device 200. Regardless of whether such computing devices 120/130 are implemented in a manner similar to computing device 200, the computing devices 120/130 may encompass a wide array of computing devices such as desktop computers, laptop computers, servers, personal digital assistants, mobile phones, music players (e.g. MP3 players), set top boxes, personal video recorders, gaming consoles as well as other types of computing devices. Furthermore, as depicted, the invitee computing device 120 and the inviter computing device in one embodiment each includes a email client 122/132 and a web browser 124/134. The email client 122/132 enables a user to compose email message, read received email messages, and send email message to recipients. The web browser 124/134 provides a web client that displays content served by a web server 112 of the invitation order system 110. In some embodiments, the web browser 124/134 may further play the role of email client. In such embodiments, the web browser 124/134 may comprise an email client as well as a web client. In another embodiment, a user may connect to a web server via a web client of the web browser in order to read and send email using webmail services provided by the web server without using a conventional email client.

The invitation order system 110 may comprise one or more computing devices that cooperate to implement an invitation order process. In one embodiment, a single computing device or server provides the services of the invitation order process. In another embodiment, a plurality of computing devices or servers provide the services of the invitation ordering process. In such an embodiment, the invitation order system 110 may be implemented using a N-tier or N-layer architecture comprising one or more web server devices 112 to handle a presentation layer of the invitation order system 110, one or more application server devices 114 to handle an application layer of the invitation ordering system 110, and one or more data servers 116 to handle a data layer of the invitation ordering system 110.

In an N-tier embodiment, the web server devices 112 generally present web pages and other content for display by a web client and receive data and requests from users via their respective web clients. The data servers 116 generally store, retrieve and manage data of the invitation order system 110. The application server devices 114 generally implement application logic which results in data being retrieved, stored and processed by data servers devices 116 based upon data and requests received by the web server devices 112. While the N-layer architecture generally assigns certain types of tasks to each layer, it should be appreciated that different embodiments may assign such tasks differently. For example, in one embodiment, user authentication may be performed solely by the web server 112 while in another embodiment the application server 114 may receive authentication data from the web server 112 and determine whether a particular login attempt was successful based upon authentication data stored by the data server devices 116.

A method used by the invitation order system 110 to initiate an invitation order is depicted in FIG. 3. In block 302, the invitation order system 110 may receive from a user or inviter authentication data used to authenticate or identify the inviter. In one embodiment, a web server device 112 of the invitation order system 110 may receive the authentication data via a web browser 134 of an inviter computing device 130. For example, the inviter may enter into the web browser 134 a username and password which are associated with or otherwise uniquely assigned to the inviter and the web browser may provide such entered data to the web server device 112. However, it should be appreciated that other authentication techniques may be incorporated such as using cryptographic keys, cryptographic hashes, IP addresses, and/or other data to authenticate the inviter and/or the inviter computing device 130.

The invitation order system 110 in blocks 304-312 may receive data or other parameters that define the invitation order. For example, the invitee may specify several parameters of the order by filling out form(s) presented by the web server device 112 via the web client 132 of the inviter computing device 130. In block 304, the invitation order system 110 may receive an order type for the invitation. In one embodiment the invitation order system 110 provides a web form that enables the inviter or meal coordinator to select the order type (e.g. take-out or delivery). Further, the invitation order system 110 in block 306 may receive a time at which or by which the invitation order is to be fulfilled by the restaurant 150. In one embodiment, the invitation order system 110 provides a web form that enables the inviter to select the order fulfillment time. In particular, the invitation order system 110 enables the inviter to select the time at which the order is to be ready for order pick-up if the order is a take-out order. Similarly, the invitation order system 110 enables the inviter to select the time at which the order is to be delivered if the order is a delivery order.

The invitation order system 110 in block 308 may receive a restaurant selection from the inviter. For a delivery order, the invitation order system 110 may provide web forms which enable the inviter to enter the information regarding the delivery location such as street address, city state, and zip code and present the inviter with a list of participating restaurants which provide delivery service to such a location during the time requested for delivery. For a pick-up order, the invitation order system 110 may provide web forms which enable the inviter to enter address information as well as a radius (e.g. 10 miles) around the entered address and present the inviter with a list of participating restaurants within the defined pick-up locale that provide pick-up service during the specified pick-up time. In either case, the inviter may then select a restaurant from the presented list of restaurants in order to provide the invitation order system 110 with the restaurant selection for the invitation order. In other embodiments, the invitation order system 110 may provide web forms that enable the inviter to specify further criteria regarding the restaurant such as price range, type of cuisine, etc. in order to further refine the list of restaurants presented to the inviter. It should be appreciated that in other embodiments, the invitation order system 110 may support a single restaurant. But, even in such an embodiment, the restaurant may have several locales and the invitation order system 110 may provide web forms which enable the inviter to select from the multiple locales of the restaurant.

In block 310, the invitation order system 110 receives parameters that define a payment method for the invitation order. In one embodiment, the invitation order system 110 may provide web forms which enable the inviter to define the payment method for the invitation order and may receive such parameters in response to the inviter completing the web form. In particular, the invitation order system 110 enables the inviter to select between each invitee of the invitation order buys their own and the inviter pays for each invitee. Moreover, if the inviter elects to pay for each invitee, the invitation order system 110 in one embodiment enables the inviter to define to define a limit or maximum dollar amount per an invitee. A maximum dollar amount per invitee may provide the inviter with piece of mind since the total cost of the invitation order is now bounded by the defined limiter per an invitee.

In block 312, the invitation order system 110 may receive a list of invitees for the invitation order. In one embodiment, the invitation order system 110 maintains an address book 118 for each inviter registered with the invitation order system 110. The invitation order system 110 may provide web forms that enable the inviter to add contacts to the address book 118 of the inviter, to remove contacts to the address book 118 of the inviter, to add distribution groups to the address book in block 304 of the inviter, to remove distribution groups to the address book 118 of the inviter, and to otherwise maintain contact information for each invitee of the address book 118. In particular, the invitation order system 110 may provide web forms which enable the inviter to enter contact information for each invitee such as the invitee's name and the invitee's email address. Further, the invitation order system 110 may provide web forms that enable the inviter to add invitees to and remove invitees from distribution groups, thus resulting in groups of invitees to which invitation orders may be delivered. Accordingly, the invitation order system 110 may receive the list of invitees as a result of the inviter selecting the invitees from the address book 118 and/or selecting one or more distribution groups from the address book 118. The invitation order system 110 may further provide web forms that enable the inviter to specify a file on the inviter computing device 130 that contains contact information for the invitees to be added to the invitation order and/or to the address book 118.

The invitation order system 110 then in block 314 may generate invitations for each of the invitees of the invitation order and in block 316 may send the generated invitations to the invitees of the invitation order. In one embodiment, the invitation order system 110 generates the invitations as personalized email messages. In particular, the invitation order system 110 generates the email messages such that the email message comprise an invitee identifier that identifies the invitee, an invitation identifier that identifies the invitation order, and an invitation order system identifier that identifies the invitation order system 110. To this end, the invitation order system 110 may generate, based upon the identifiers for the invitation order system, the invitation order, and the invitee, a hyperlink that links the invitee to the invitation order system 110 and the invitation order to which the invitee has been invited. In one embodiment, the hyperlink comprises a URI (universal resource identifier) such as a URL (universal resource locator). A URL typically comprises a protocol, login, host, port, path, query, and/or fragment portions as depicted below:

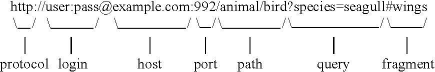

For example, the invitation order system 110 may generate the hyperlink such that the host section includes the domain name or IP address associated with the invitation order system 110. As a result, an invitee may merely active the hyperlink of the email message to cause a web client 124 to connect with the invitation order system 110 associated with the domain name or IP address. The invitation order system 110 may further generate the hyperlink such that the hyperlink provides an invitee identifier and invitation order identifier.

It should be appreciated that the invitation order system 110 may utilize various techniques for embedding the invitee identifier and invitation order identifier in the hyperlink. For example, the invitation order system 110 may include the invitee identifier and/or invitation order identifier as parameters of the query portion of the hyperlink. The invitation order system 110 alternatively associate a unique path for each invitee and/or invitation order and merely embedded the associated unique path in the path portion of the hyperlink. In another embodiment, the invitation order system 110 may include the invitee identifier in the login portion of the hyperlink. In yet another embodiment, the invitation order system 110 may rely on cookie or other file stored by the web browser to provide the invitee identifier when the invitee connects to the invitation order system 110. In another embodiment, the invitation order system 110 may simply provide the invitee identifier and invitation order identifier as textual information of the invitation and request the invitee to manually enter such information when connecting to the invitation order system 110. Many other schemes for generating the invitation in a manner that enables the invitee to connect with the invitation order system 110 and locate the appropriate invitation order should be apparent to those skilled in the art based upon the described embodiments.

Referring now to FIG. 4, a method of adding menu items selected by an invitee to the invitation order is depicted. In block 402, the invitation order system 110 authenticates or identifies the invitee. To this end, the invitation order system 110 may receive authentication data such as an invitee identifier or username and a password in response to the invitee manually entering such information via a web client 124. In another embodiment, the invitation order system 110 may receive an invitee identifier in response to a web client 124 following a hyperlink that has been generated to provide the invitee identifier as described above.

The invitation order system 110 in block 404 may identify the invitation order associated with the invitee. Similar to block 402, the invitation order system 110 may receive an invitation order identifier in response to a web client 124 following a hyperlink that has been generated to provide the invitation order identifier as described above. In yet another embodiment, the invitation order system 110 may provide the invitee with a web form which enables the invitee to manually enter the invitation order identifier.

The invitation order system 110 may then present the invitee with a menu for the restaurant that was selected to process the invitation order (block 406) and may receive menu items selections from the invitee via the web client 124 (block 408). To this end, the invitation order system 110 may provide a web client 124 of the invitee computing device 120 with a description of food, beverage and/or dessert items that may be ordered from the restaurant, and the web client 124 may display such received information to the invitee. The invitation order system 110 may further provide pricing data to the web client 124 so that such prices for the various menu items may be presented to the invitee. Furthermore, the invitation order system 110 may provide the menu data to the web client 124 in a form that results in the web client 124 presenting the menu data in a manner that enables the invitee to select or order menu items.

The invitation order system 110 in block 410 may verify that the invitee order has a predetermined relationship with respect to a limit or a maximum order amount set by the inviter for each invitee order of the invitation order. In one embodiment, in response to determining the invitee order exceeds the set limit, the invitation order system 110 in block 412 may inform the invitee that the order exceeds a defined limit and return to block 406 so that the invitation order system 110 may present the menu and allow the invitee to modify the invitee order.

In response to determining that the invitee order satisfies the defined limit criteria, the invitation order system 110 may store the invitee order and/or deliver the invitee order to the restaurant for fulfillment in block 414. In one embodiment, the invitation order system 110 forwards the invitee order to the restaurant once the invitee places the order. In another embodiment, the invitation order system 110 collects the invitee orders associated with the invitation order and forwards all the invitee orders to the restaurant once the invitation order is complete. The communication device 152 of the restaurant 150 may receive the invitee orders and the restaurant 150 may fulfill the invitee orders per the criteria specified for the invitation order.

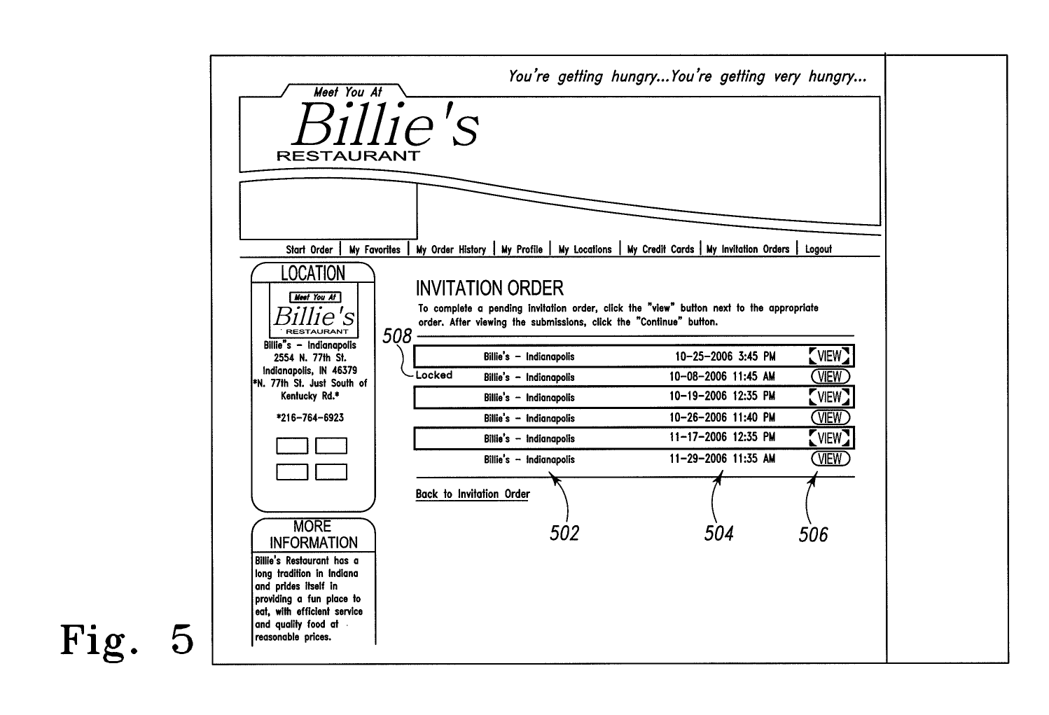

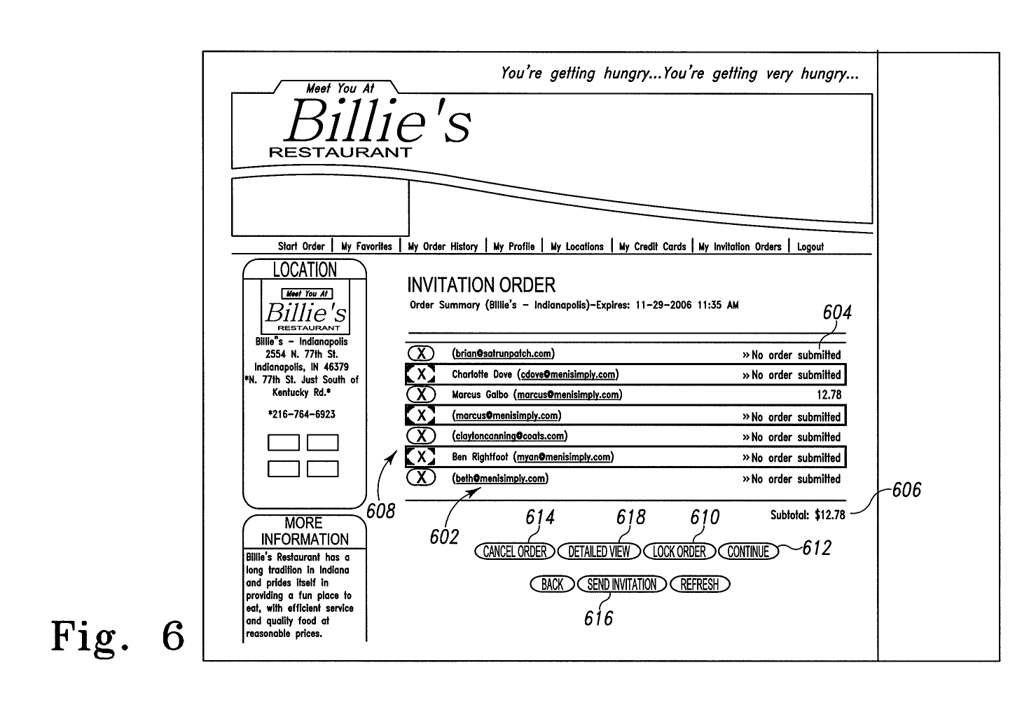

As depicted in FIGS. 5-6, the invitation order system 110 may further provide web forms which enable the inviter or meal coordinator to review invitation orders. In particular, FIG. 5 depicts a pending orders web form or web page that lists pending invitation orders as well as a short description of each pending order. As depicted, the pending orders page provides a restaurant identifier 502 that identifies the restaurant and a date and time 504 that indicates when the restaurant is to fulfill the invitation order. The pending orders page also provides a status indicator 508. The status indicator 508 in one embodiment indicates whether the respective invitation order has been locked. The invitation order system 110 enables the inviter to lock the invitation order in order to prevent invitees from adding further menu items to the invitation order. The invitation order system 110 may further automatically lock the invitation order in response to submitting the invitation order to the restaurant for fulfillment.

The pending orders page further provides buttons 506 which enable the inviter to select and view additional details regarding a particular pending invitation order. In particular, as shown in FIG. 6, the invitation order system 110 may provide a summary page for a pending invitation order in response to the invitee activating the button 506 associated with the pending invitation order. As depicted, summary page provides invitee identifiers 602 that identify the invitees associated with the pending invitation order. The summary page also provides a status identifier 604 for each invitee. In one embodiment, the status identifier 604 identifies whether the invitee has submitted the invitee order. Further, if the invitee has submitted his or her order, then the status identifier 604 further indicates the cost associated with the invitee order. The summary page further provides a subtotal 606 for the invitation order that provides the total sum of the individual invitee orders that make-up the invitation order.

The summary page also provides remove buttons 608 that enable an inviter to remove an invitee from the invitation order, a lock order button 610 that enables the inviter to lock the invitation order as described above, and a continue button 612 that enables the inviter to continue or submit the invitation order to the invitation order system 110. The summary page may also provide a cancel button 614 which enables the inviter to cancel the invitation order, a send invitation button 616 which enables the inviter to request the invitation order system 110 to send invitations to the invitees, and a detailed view button 618 which enables the inviter to request a detailed view of the invitation order from the invitation order system 110. In one embodiment, the invitation order system 110 provides the inviter with an itemized breakdown of the menu items selected by each invitee in response to the inviter activating the detailed view button 618.

While certain features of the invention have been described with reference to various embodiments, the description is not intended to be construed in a limiting sense. Various modifications of the described embodiments, as well as other embodiments of the invention, which are apparent to persons skilled in the art to which the invention pertains are deemed to lie within the spirit and scope of the invention.

What is claimed is:

1. A method, comprising
defining a list of invitees for an order to a restaurant, and
emailing each invitee of the list of invitees an invitation to add restaurant items to the order.

2. The method of claim 1, further comprising generating, for each invitee of the list of invitees, an invitation that includes authentication data that associates the invitee with the invitation order.

3. The method of claim 1, further comprising generating, for each invitee of the list of invitees, a invitation that includes a hyperlink that associates the invitee with the invitation order.

4. The method of claim 1, further comprising presenting a menu of the restaurant to an invitee via a web client in response to the invitee responding to the invitation.

5. The method of claim 1, further comprising receiving restaurant item selections from an invitee via a web client in response to the invitee responding to the invitation.

6. The method of claim 1, further comprising
receiving a request from an invitee of the list of invitees to add restaurant items to the order, and
denying the request in response to determining the order has been locked.

7. The method of claim 1, further comprising
receiving a request from an invitee of the list of invitees to add restaurant items to the order, and
denying the request in response to determining the restaurant items requested by the invitee has a predefined relationship to a limit defined for an invitee order.

8. A machine readable medium, comprising a plurality of instructions that in response to being executed result in a computing device
receiving parameters from a web client that define an invitation order for a restaurant, said parameters identifying a plurality of invitees,
generating an invitation for each invitee of the plurality of invitees, the invitation comprising authentication data that identifies the invitee and the invitation order, and
transmitting the invitation for each invitee to the corresponding invitee.

9. The machine readable medium of claim 8 wherein the plurality of instructions further result in the computing device
maintaining an address book comprising contact information for a plurality of persons, and
defining the plurality of invitees based upon said parameters selecting the invitees from the plurality of persons of the address book.

10. The machine readable medium of claim 8 wherein the plurality of instructions further result in the computing device
adding, to the invitation for each invitee, an invitee identifier that identifies the invitee and an order identifier that identifies the invitation order associated with the invitation.

11. The machine readable medium of claim 8 wherein the plurality of instructions further result in the computing device
adding, to the invitation for each invitee, a hyperlink that comprises an invitee identifier that identifies the invitee and an order identifier that identifies the invitation order associated with the invitation.

12. The machine readable medium of claim 8 wherein the plurality of instructions further result in the computing device
presenting a menu of the restaurant to an invitee via a web client in response to the invitee responding to the invitation.

13. The machine readable medium of claim 8 wherein the plurality of instructions further result in the computing device
receiving a request to add restaurant items to the invitation order, and
denying the request in response to determining the order has been locked.

14. The machine readable medium of claim 8 wherein the plurality of instructions further result in the computing device
receiving a request to add restaurant items to the invitation order, and
denying the request in response to determining the restaurant items requested by the invitee have a predefined relationship to a limit defined for an invitee order.

15. A invitation order system for use with a plurality of web clients, the invitation order system comprising one or more computing devices that each comprise a network interface, memory and a processor, wherein the one or more computing devices cooperate to
receive parameters from a web client of the plurality of web clients, the parameters identifying a restaurant and selecting a plurality of invitees to invite to an invitation order for the restaurant,
generate a plurality of invitations for the plurality of invitees, each invitation providing a textual message instructing the invitee how to use a web client of the plurality of web clients to add their order to the invitation order, and
transmitting to each invitee their respective invitation.

16. The invitation order system of claim 15, wherein the one or more computing devices further cooperate to
store an address book comprising contact information for a plurality of persons, and
select the plurality of invitees from the address book based upon said parameters.

17. The invitation order system of claim 15, wherein the one or more computing devices further cooperate to
generate the invitation for each invitee to include an invitee identifier that identifies the invitee and an order identifier that identifies the invitation order associated with the invitation.

18. The invitation order system of claim 15, wherein the one or more computing devices further cooperate to
generate the invitation for each invitee to include a hyperlink that comprises an invitee identifier that identifies the invitee and an order identifier that identifies the invitation order associated with the invitation.

19. The invitation order system of claim 15, wherein the one or more computing devices further cooperate to
present a menu of the restaurant to an invitee in response to the invitee communicating with the invitation order system based upon data provided by the invitation.

20. The invitation order system of claim 15, wherein the one or more computing devices further cooperate to
add restaurant items selected by an invitee to the invitation order in response to the invitee communicating with the invitation order system based upon data supplied by the invitation.
